(19) United States
(12) Patent Application Publication
(10) Pub. No.: US 2004/0006846 A1
(43) Pub. Date: Jan. 15, 2004

(54) Hinge

(76) Inventor: Helmut Rupprechter, Dornbirn (AT)

Correspondence Address: WENDEROTH, LIND & PONACK, L.L.P., 2033 K STREET N. W., SUITE 800, WASHINGTON, DC, 20006-1021, US

(21) Appl. No.: 10/447,141

(22) Filed: May 29, 2003

(30) Foreign Application Priority Data
Jul. 15, 2002 (AT) GM 469/2002

(51) Int. Cl. E05D 7/04

(52) U.S. Cl. 16/235

(57) ABSTRACT

A hinge for anchoring a door leaf (2) to a frame (1) of an item of furniture, having a base plate (5) that may be secured to the frame (1) and having an intermediate piece (3) on which there is mounted a hinge arm (4) connected to a hinge pot (8) that may be secured to the door leaf (2) by way of at least one articulating pin (9). Adjusting and/or fixing means are provided by means of which the hinge arm (4) may be fixed in different positions on the intermediate piece (3). The intermediate piece (3) is provided with a bracket (15) that has lateral marginal projections (15′) and is punched out of the intermediate piece (3). The hinge arm (4) has a region that is C-shaped in cross-section. Inwardly directed projections (7) of this region reach behind the marginal projections (15′) of the bracket (15), as a result of which the hinge arm (4) is anchored to the bracket (15).

The invention relates to a hinge for anchoring a door leaf to a frame of an item of furniture, having a base plate that may be secured to the frame and on which a hinge arm is mounted directly or indirectly by way of an intermediate piece to which a hinge pot that may be secured to the door leaf is connected by way of at least one articulating pin, with at least one adjusting and/or fixing means being provided by means of which the hinge arm may be fixed in different positions on the base plate or on the intermediate piece, and a bracket or the like to which the hinge arm is anchored being punched out of the base plate or the intermediate piece.

In modern furniture making, what are commonly called door frames are being used more and more widely, these frames forming a stable part that bears the hinges for the door leaves and the actual side walls of the furniture carcass being made from relatively weak material. This creates the advantage either that the overall costs of the item of furniture can be reduced, since the side walls can be extremely thin, or that higher-quality and hence visually more attractive materials can be selected for the side walls without the items of furniture being expensive by comparison with furniture made in conventional ways.

A hinge of this kind is known from EP 1 030 021 A2.

The object of the invention is, with a hinge of this kind, to achieve good anchoring of the hinge arm with simple means, there being the possibility that the position of the hinge arm may be adjusted.

The object of the invention is achieved in that the bracket, which extends in the longitudinal direction of the hinge arm, has lateral marginal projections that are punched out of the base plate or the intermediate piece in one piece with the bracket, and in that the hinge arm has a region that is C-shaped in cross-section and by means of which it may be pushed onto the bracket, with inwardly directed projections of the C-shaped region reaching behind the marginal projections of the bracket.

Various example embodiments of the invention will be described below with reference to the figures in the attached drawings, in which:

FIG. 1 shows diagrammatically a frame portion and a section of a door, which are connected to one another by a hinge according to an example embodiment of the invention,

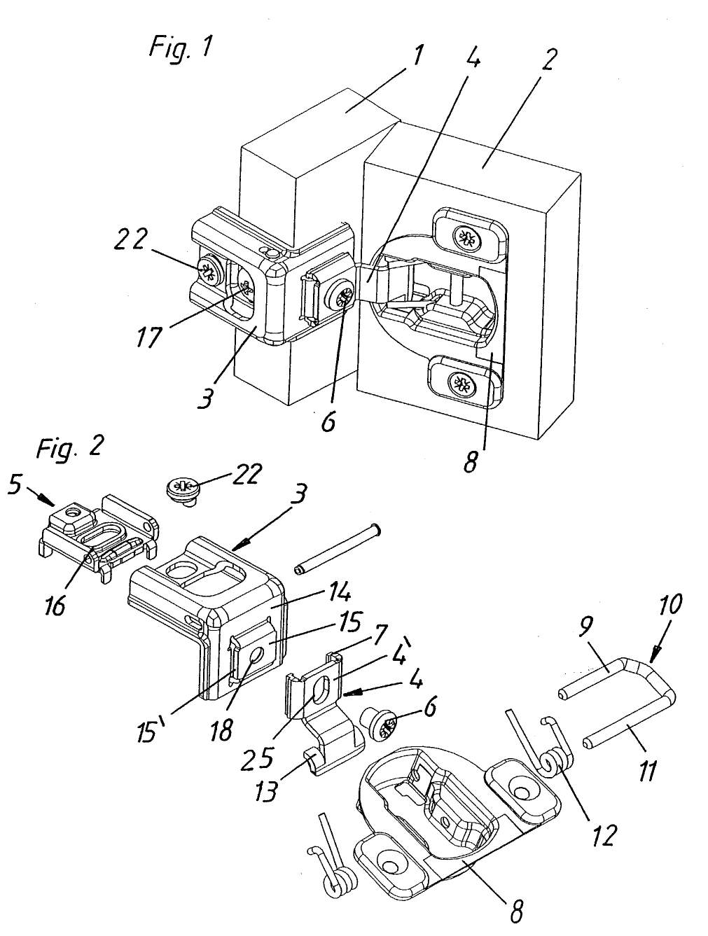

FIG. 2 shows diagrammatically and in exploded view a hinge according to the invention,

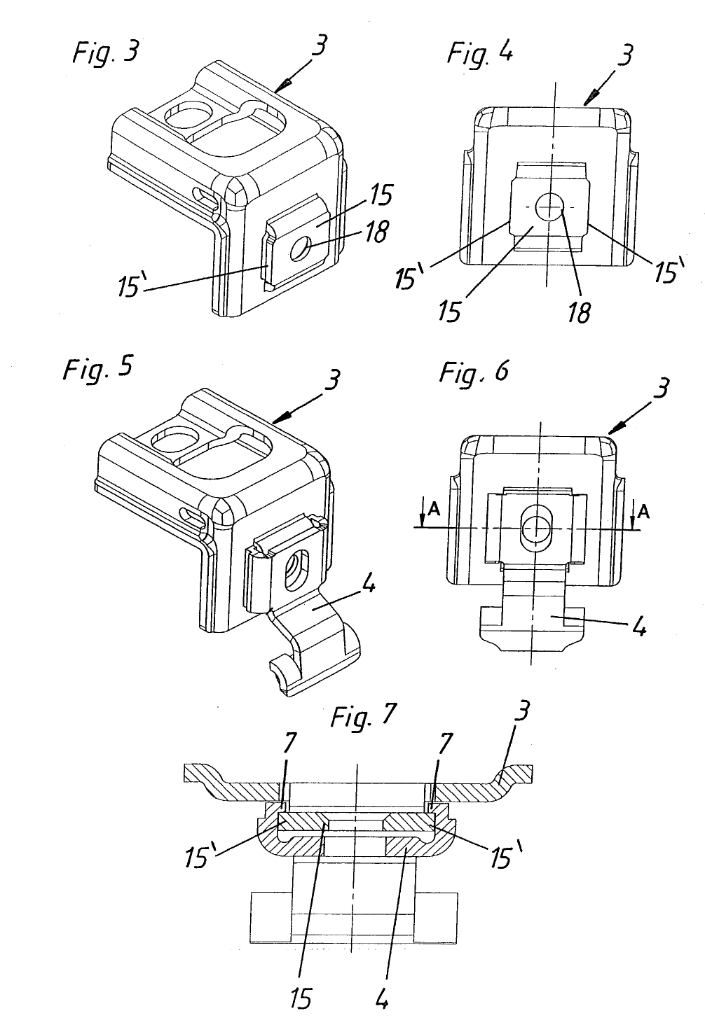

FIG. 3 shows a diagram of an intermediate piece,

FIG. 4 shows an end view of an intermediate piece,

FIG. 5 shows a diagram of an intermediate piece and a hinge arm, with the hinge arm hooked into the intermediate piece,

FIG. 6 shows an end view of an intermediate piece with the hinge arm hooked in,

FIG. 7 shows a section along the line A-A in FIG. 6,

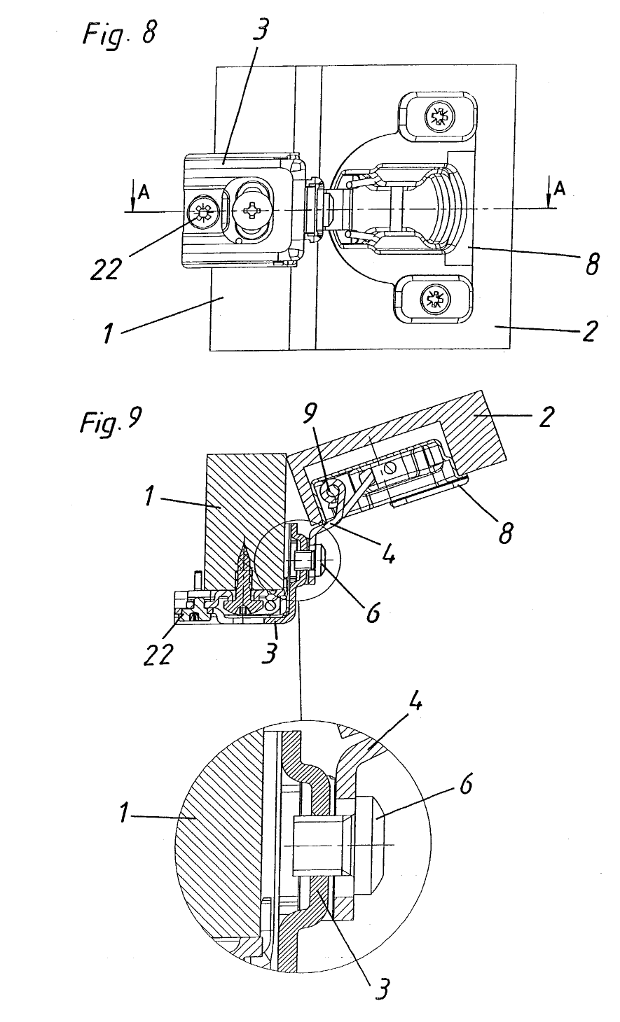

FIG. 8 shows a plan view of a hinge according to the invention,

FIG. 9 shows a section along the line A-A in FIG. 8,

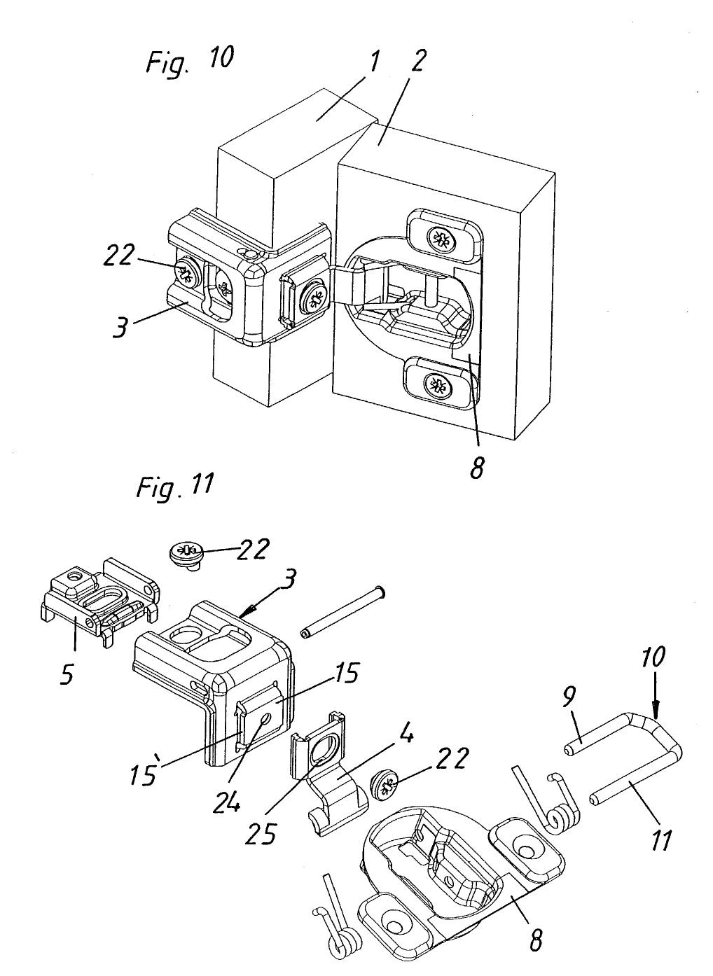

FIG. 10 shows diagrammatically a frame portion and a section of a door, which are connected to one another by a hinge according to a further example embodiment of the invention,

FIG. 11 shows diagrammatically and in exploded view the example embodiment of a hinge according to the invention from FIG. 10,

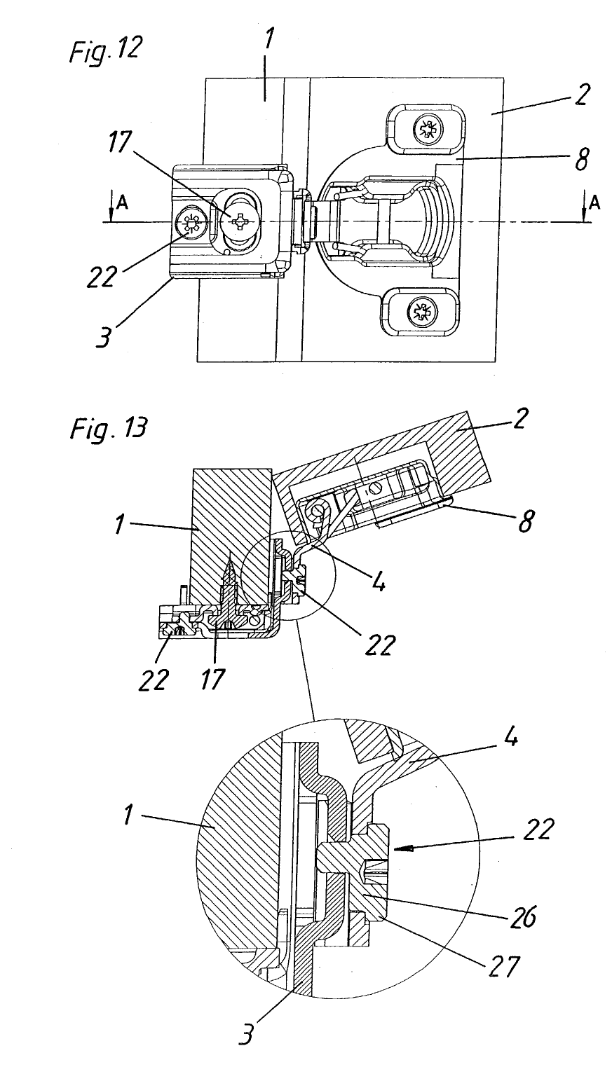

FIG. 12 shows a plan view of the hinge according to the invention,

FIG. 13 shows a section along the line A-A in FIG. 12,

FIG. 14 shows diagrammatically a frame portion and a section of a door, which are connected to one another by a hinge according to a further example embodiment of the invention,

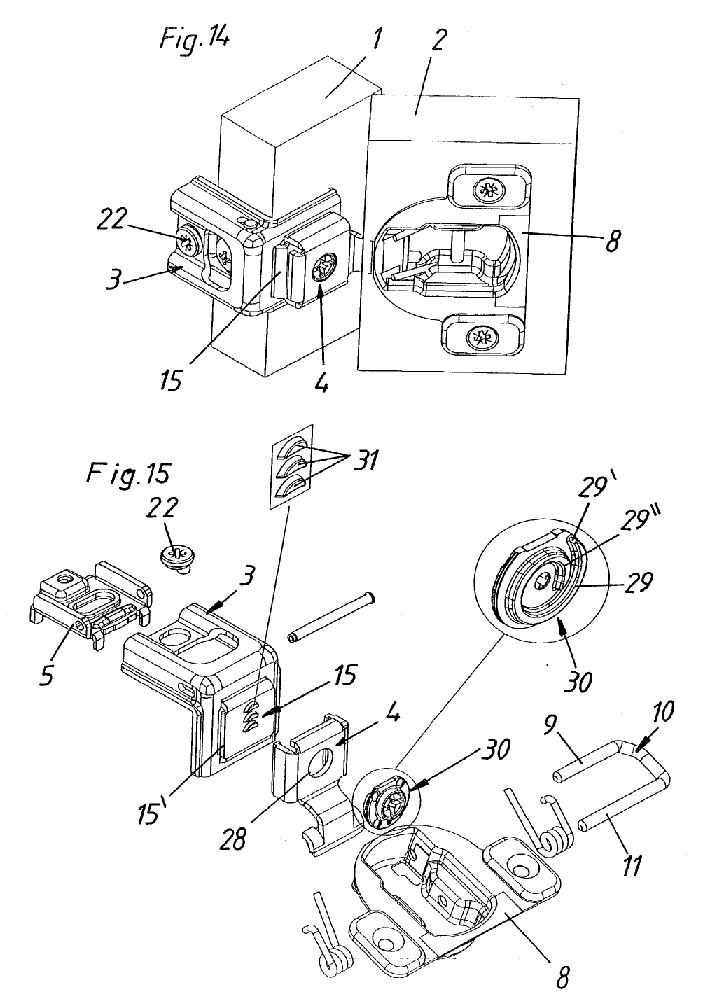

FIG. 15 shows diagrammatically and in exploded view the hinge according to the invention in the example embodiment of FIG. 14,

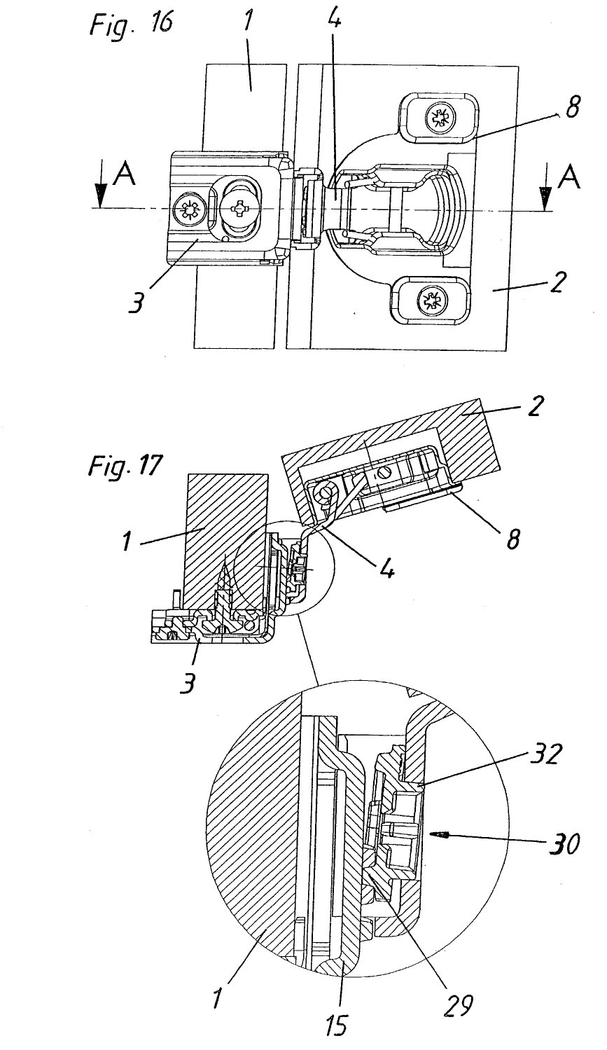

FIG. 16 shows a plan view of a hinge according to the invention,

FIG. 17 shows a section along the line A-A in FIG. 16,

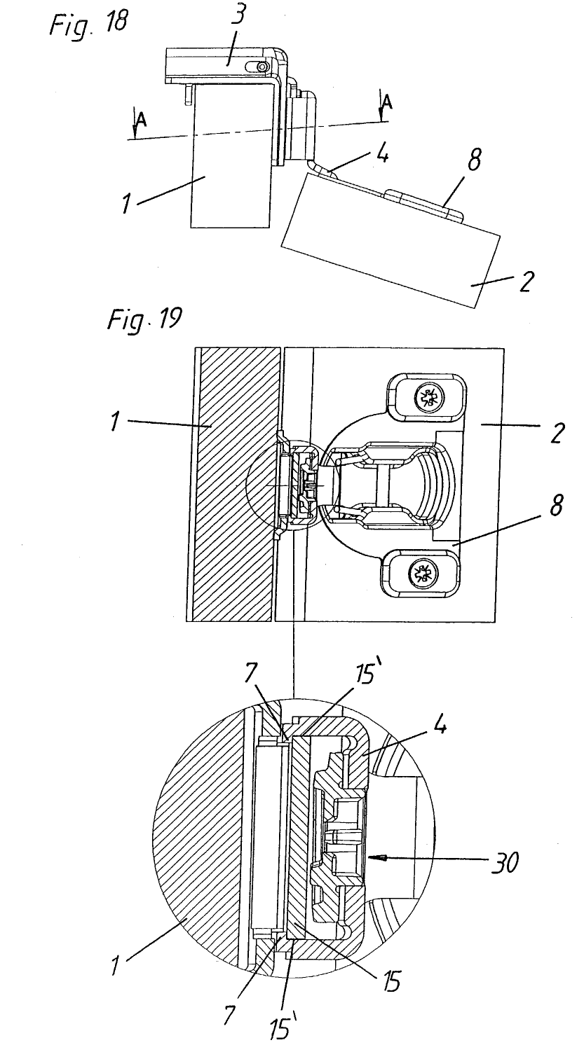

FIG. 18 shows a plan view of a hinge, seen in the direction of the hinge pin, and

FIG. 19 shows a section along the line A-A in FIG. 18.

In the figures of the drawings, of the item of furniture only sections of the door frame 1 and the door leaf 2 are shown. The door leaf 2 is anchored to the furniture frame 1 by means of two or more hinges according to the invention. Directly on the furniture frame 1 there is mounted a base plate 5 that, in the example embodiment, reaches around the door frame 1 in the shape of a U.

A hinge pot 8 is inserted in a bore in the door leaf 2, and the hinge arm 4 is mounted in the hinge pot 8 by means of a hinge pin 9, with the hinge pot 8 rotatable or tiltable about the hinge pin 9 in relation to the hinge arm 4.

In the example embodiments shown, the hinge pin 9 is formed by a peg of a bracket 10 that projects laterally through the hinge pot 8. Mounted on the rear peg 11 of the bracket 10 are springs 12 that abut with one limb against pressure faces 13 of the hinge arm 4 and so hold the hinge pot 8 and the door leaf 2 in the closed position.

Mounted on the base plate 5 is an intermediate piece 3 that is L-shaped in side view. The base plate 5 and the intermediate piece 3 are preferably made from sheet steel. The base plate 5 has an elongate hole 16 through which there projects a screw 17 by means of which the base plate 5 is secured to the furniture frame 1. The elongate hole 16 allows the height of the hinge in the item of furniture to be adjusted.

A bracket 15 that extends in the longitudinal direction of the hinge arm 4 is punched out of the web 14 of the intermediate piece 3 that abuts against the front side of the frame 1. The hinge arm 4 is pushed onto this bracket 15 and thus anchored to the intermediate piece 3. The bracket 15 could also be punched directly out of the base plate 5. The effect of the intermediate piece 3 is to gain an additional possibility of adjustment in the depth direction of the item of furniture, with the intermediate piece 3 being displaceable on the base plate 5 by means of an eccentric 22.

The bracket 15 is punched out of the intermediate piece 3 such that it has laterally projecting marginal projections 15′. The hinge arm 4 has a C-shaped region 4′ with inwardly directed projections 7. When the hinge arm 4 is pushed onto the bracket 15 the projections 7 of the hinge arm 4 reach behind the marginal projections 15′ of the bracket 15.

In the example embodiment according to FIGS. 1 to 7, the bracket 15 has a threaded bore 18 in which a clamping screw 6 is mounted. The hinge arm 4 is provided with an elongate hole 25 aligned perpendicular to the hinge pin 9.

The hinge arm 4 is clamped to the bracket 15 in the assembled position by tightening the clamping screw 6. If the clamping screw 6 is slightly loosened, it is possible to adjust the hinge arm 4 perpendicular to the hinge pin 9, as a result of which an adjustment to the door leaf 2 in the direction of the furniture join is achieved. The projections 7 of the hinge arm 4 are in this case displaced along the marginal projections 15′ of the bracket 15.

In the example embodiment according to FIGS. 10 to 13, the hinge arm 4 is adjusted directly by the eccentric 22.

In the assembled position, the hinge arm 4 is once again pushed onto the bracket 15, with the projections 7 of the hinge arm 4 reaching behind the marginal projections 15′ of the bracket 15.

An adjustment to the hinge arm 4 in the direction of the furniture join is achieved by means of the eccentric 22, which is mounted rotatably in a hole 24 in the bracket 15 by means of a peg 23.

The hinge arm 4 is once again provided with an elongate hole 25 but this time it is aligned transversely with respect to the hinge arm 4.

The eccentric cam 26 of the eccentric 22 is received in the elongate hole 25 in the assembled position.

The eccentric 22 is riveted in the bracket 15 by its peg 23 and has a head 27 abutting against the outside of the bracket 15. As a result of this construction, the hinge arm 4 is held against the intermediate piece 3 non-detachably.

In the example embodiment according to FIGS. 14 to 19, an adjustment to the position of the hinge arm 4 is achieved by means of a spiral washer 30. The spiral washer 30 is mounted in a mounting seat 28 in the hinge arm 4 and has a web-shaped spiral 29 that is supported against cam-type projections 31 constructed on the bracket 15. The mounting seat 28 is formed by a punched hole.

In the example embodiment shown, the spiral 29 has two overlapping sections 29′, 29″.

The spiral washer 30 is provided with a base 32 that is received in the mounting seat 28 of the hinge arm 4 and enables access for an adjustment tool such as a screwdriver.

Turning the spiral washer 30 displaces the hinge arm 4 on the bracket 15 in the direction of the furniture door join.

1. A hinge for anchoring a door leaf to a frame of an item of furniture, having a base plate that may be secured to the frame and on which a hinge arm is mounted directly or indirectly by way of an intermediate piece to which a hinge pot that may be secured to the door leaf is connected by way of at least one articulating pin, with at least one adjusting and/or fixing means being provided by means of which the hinge arm may be fixed in different positions on the base plate or on the intermediate piece, and a bracket or the like to which the hinge arm is anchored being punched out of the base plate or the intermediate piece, wherein the bracket, which extends in the longitudinal direction of the hinge arm, has lateral marginal projections that are punched out of the base plate or the intermediate piece in one piece with the bracket, and wherein the hinge arm has a region that is C-shaped in cross-section and by means of which it may be pushed onto the bracket, with inwardly directed projections of the C-shaped region reaching behind the marginal projections of the bracket.

2. A hinge as claimed in claim 1, wherein the bracket has a flat central portion, and wherein the marginal projections extend over the length of the central portion.

3. A hinge as claimed in claim 1, wherein there is provided in the bracket, a threaded bore in which a clamping screw is mounted that projects through an elongate hole in the hinge arm.

4. A hinge as claimed in claim 3, wherein the threaded bore is provided in the flat central portion of the bracket.

5. A hinge as claimed in claim 1, wherein an eccentric is mounted in the bracket and projects into an elongate hole in the hinge arm.

6. A hinge as claimed in claim 5, wherein the eccentric is mounted in the flat central portion of the bracket.

7. A hinge as claimed in claim 1, wherein a spiral washer is mounted in the hinge arm and has on the side facing the bracket a web-shaped spiral that abuts against at least one projection on the bracket.

8. A hinge as claimed in claim 7, wherein a plurality of projections arranged in a row are provided on the bracket.
